(19) United States
(12) Patent Application Publication
(10) Pub. No.: US 2024/0206677 A1
(43) Pub. Date: Jun. 27, 2024

(54) GRILL WITH AN INTEGRATED AIR FILTRATION SYSTEM

(71) Applicant: Timothy Jackovitch, Ellijay, GA (US)

(72) Inventor: Timothy Jackovitch, Ellijay, GA (US)

(21) Appl. No.: 18/543,806

(22) Filed: Dec. 18, 2023

Related U.S. Application Data
(60) Provisional application No. 63/476,998, filed on Dec. 23, 2022.

(51) Int. Cl. A47J 37/07; A47J 36/38

(52) U.S. Cl. CPC A47J 37/0754; A47J 36/38

(57) ABSTRACT

Disclosed is a grill with an integrated air filtration system. The air filtration system is configured to draw smoke from the cooking chamber of the grill and filter the smoke prior to expelling it from the grill. An example air filtration system comprises a duct that includes a series of filters, an air handling chamber positioned within a cabinet assembly of the grill, and an exhaust blower. The air filtration system is in fluid communication with the cooking chamber of the grill via at least one vent in a portion of the grill body that separates the cooking chamber and the duct. The exhaust blower is configured to draw smoke from the cooking chamber, through the duct and the series of filters, and then through the air handling chamber, before expelling filtered smoke from the grill.

### CROSS-REFERENCE TO RELATED APPLICATION(S)

This application claims the benefit of U.S. Provisional Application Ser. No. 63/476,998, filed on Dec. 23, 2022, the entirety of which is incorporated herein by reference.

### TECHNICAL FIELD

This disclosure relates to a grill with an integrated air filtration system.

### BACKGROUND

Throughout culinary history, grills have been essential for cooking food using direct heat. These traditional grills, which typically use charcoal, gas, or electricity for heating, consist of a grate or mesh for placing food. However, they present several issues, such as uneven heat distribution, challenges in temperature control and maintenance, and environmental concerns, particularly with charcoal grills. Notably, one significant issue is the production of smoke, which can be bothersome and environmentally harmful.

During grilling, grease from the food naturally drips onto the heat source. This grease, a combination of oils and fats, is then vaporized, contributing significantly to the smoke produced by the grill. While this smoke is essential for imparting a distinctive flavor to the grilled food, it also contains various impurities. These impurities, which often include substances that result in unpleasant odors, can potentially be harmful if inhaled or released into the environment. Therefore, an air filtration system that captures grease-laden smoke and filters out impurities would be desirable.

Accordingly, needs exist for the grill with an integrated air filtration system disclosed herein. It is to the provision of a grill with an integrated air filtration system configured to address these needs, and others, that the present invention is primarily directed.

### SUMMARY OF THE INVENTION

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is a grill with an integrated air filtration system. The air filtration system is configured to draw smoke from the cooking chamber of the grill and filter the smoke prior to expelling it from the grill.

An example air filtration system comprises a duct that includes a series of filters, an air handling chamber positioned within a cabinet assembly of the grill, and an exhaust blower. The air filtration system is in fluid communication with the cooking chamber of the grill via at least one vent in a portion of the grill body that separates the cooking chamber and the duct. The exhaust blower is configured to draw smoke from the cooking chamber, through the duct and the series of filters, and then through the air handling chamber, before expelling filtered smoke from the grill.

Another example air filtration system comprises a duct that includes a series of filters, a damper, an air handling chamber positioned within a cabinet assembly of the grill, and an exhaust blower. The air filtration system is in fluid communication with the cooking chamber of the grill via an intake slot in a portion of the grill body that separates the cooking chamber and the duct. The damper is operably connected to the lid and configured to selectively occlude the intake slot. The exhaust blower is configured to draw smoke from the cooking chamber, through the duct and the series of filters, and then through the air handling chamber, before expelling filtered smoke from the grill.

In some implementations, the air handling chamber is dimensioned to serve as an expansion chamber for filtered smoke exiting the duct, and includes at least one baffle positioned to affect air flow through the air handling chamber.

### BRIEF DESCRIPTION OF THE DRAWINGS

FIG. 1 illustrates an isometric view of a grill with an integrated air filtration system according to the principles of the present disclosure.

FIG. 2 illustrates another isometric view of the grill with the integrated air filtration system shown in FIG. 1.

FIG. 3 illustrates a front elevational view of the grill with the integrated air filtration system shown in FIG. 1, wherein the doors of the cabinet assembly are open.

FIG. 4 illustrates a left side elevational view of the grill with the integrated air filtration system shown in FIG. 1.

FIG. 5 illustrates a right side elevational view of the grill with the integrated air filtration system shown in FIG. 1.

FIG. 6 illustrates a rear elevational view of the grill with the integrated air filtration system shown in FIG. 1, wherein the door used to access the interior of the duct, the bypass vent, and the door covering the first filter are open.

FIG. 7 illustrates a top plan view of the grill with the integrated air filtration system shown in FIG. 1.

FIG. 8 illustrates a cross-sectional view of the grill with the integrated air filtration system taken along line 8-8. The illustrated arrow indicates the flow path of filtered smoke being drawn through the air handling chamber of the air filtration system.

FIG. 9 illustrates a cross-sectional view of the grill with the integrated air filtration system taken along line 9-9. The illustrated arrows indicate the flow path of smoke being drawn into and through the duct of the air filtration system.

FIG. 9A illustrates an enlarged portion of the grill with the integrated air filtration system shown in FIG. 9.

FIG. 10 illustrates a cross-sectional view of the grill with the integrated air filtration system taken along line 10-10.

FIG. 11 illustrates an isometric exploded view of the grill with the integrated air filtration system shown in FIG. 1.

FIG. 12 illustrates an isometric view of another grill with an integrated air filtration system according to the principles of the present disclosure.

FIG. 13 illustrates another isometric view of the grill with the integrated air filtration system shown in FIG. 12.

FIG. 14 illustrates a front elevational view of the grill with the integrated air filtration system shown in FIG. 12.

FIG. 15 illustrates a left side elevational view of the grill with the integrated air filtration system shown in FIG. 12.

FIG. 16 illustrates a right side elevational view of the grill with the integrated air filtration system shown in FIG. 12.

FIG. 17 illustrates a rear elevational view of the grill with the integrated air filtration system shown in FIG. 12.

FIG. 18 illustrates a cross-sectional view of the grill with the integrated air filtration system taken along line 18-18. The illustrated arrows indicate the flow path of smoke and ambient air being drawn into and through the duct of the air filtration system.

FIG. 19 illustrates a cross-sectional view of the grill with the integrated air filtration system taken along line 19-19.

FIG. 20 illustrates a cross-sectional view of the grill with the integrated air filtration system taken along line 20-20, wherein the lid of the grill is in the open position. The illustrated arrows indicate the flow path of smoke being drawn into and through the duct of the air filtration system.

FIG. 21 illustrates a cross-sectional view of the grill with the integrated air filtration system taken along line 21-21, wherein the lid of the grill is in the open position.

FIG. 22 illustrates a front elevational view of the grill with the integrated air filtration system shown in FIG. 12, wherein the front panel of the cabinet assembly has been removed.

FIG. 23 illustrates a cross-sectional view of the grill with the integrated air filtration system taken along line 23-23. The illustrated arrow indicates the flow path of filtered smoke being drawn through the air handling chamber of the air filtration system.

FIG. 24 illustrates an isometric exploded view of the grill with the integrated air filtration system shown in FIG. 12.

Like reference numerals refer to corresponding parts throughout the several views of the drawings.

### DETAILED DESCRIPTION

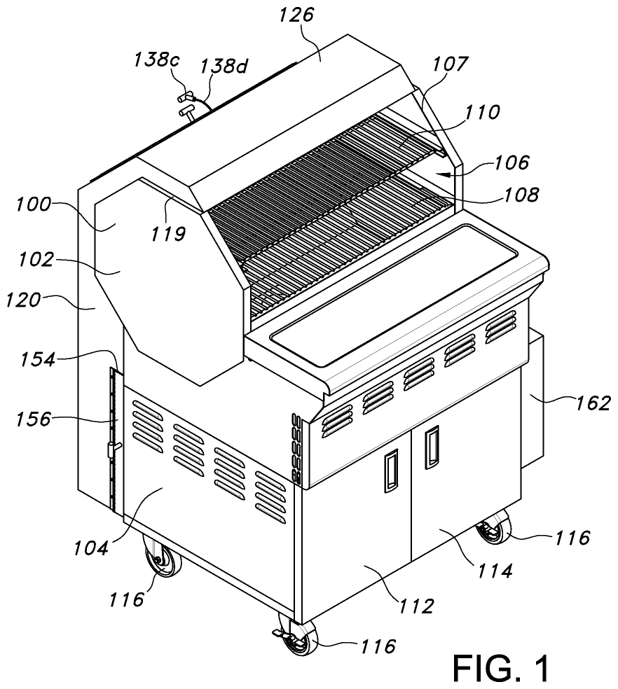

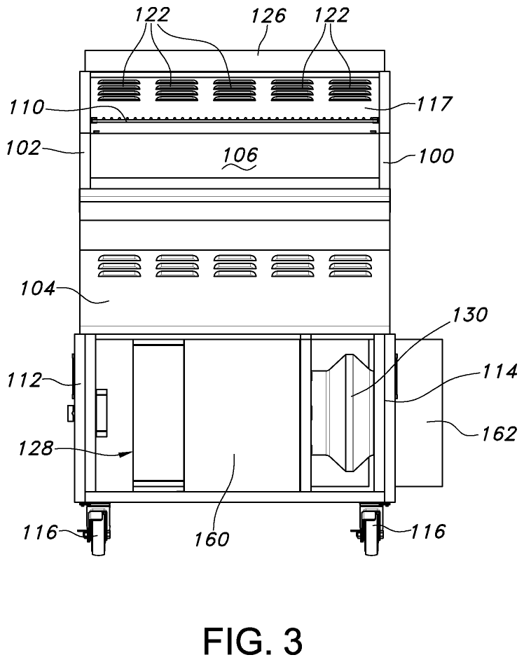

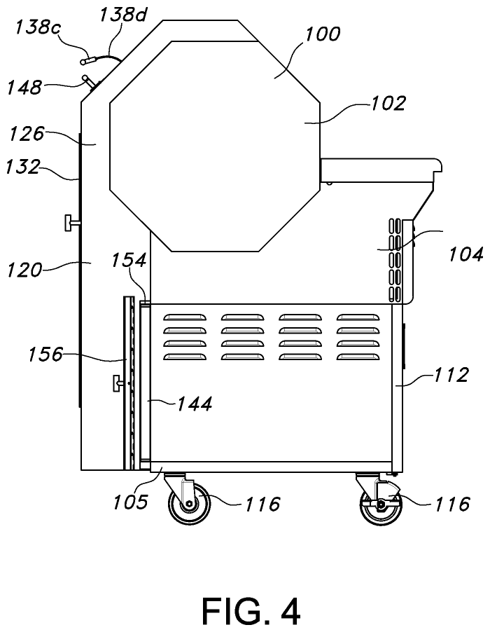

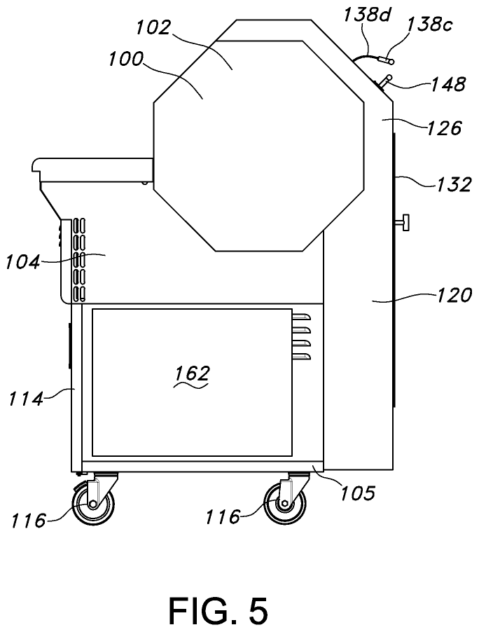

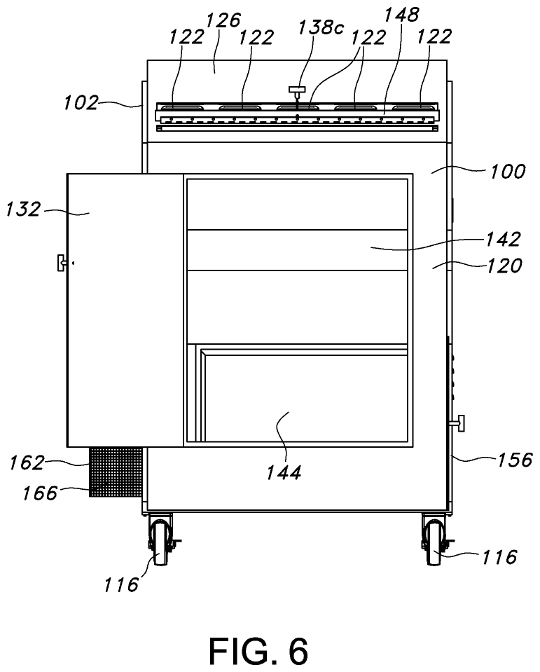

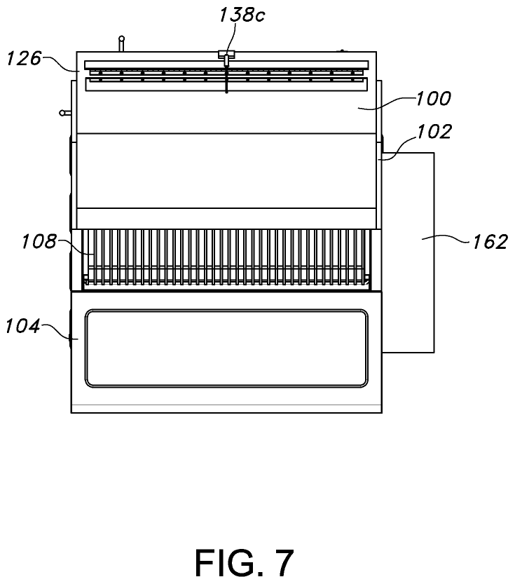

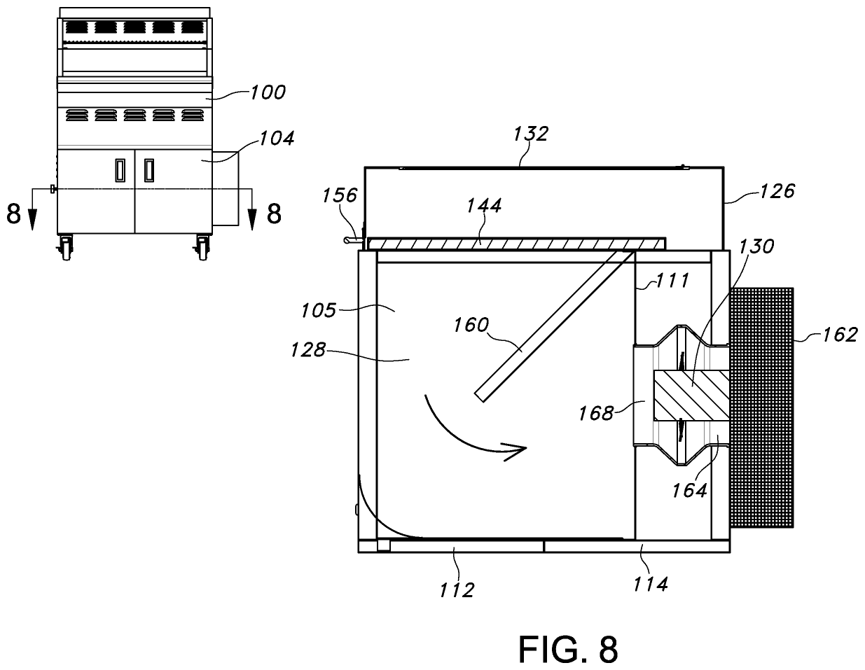

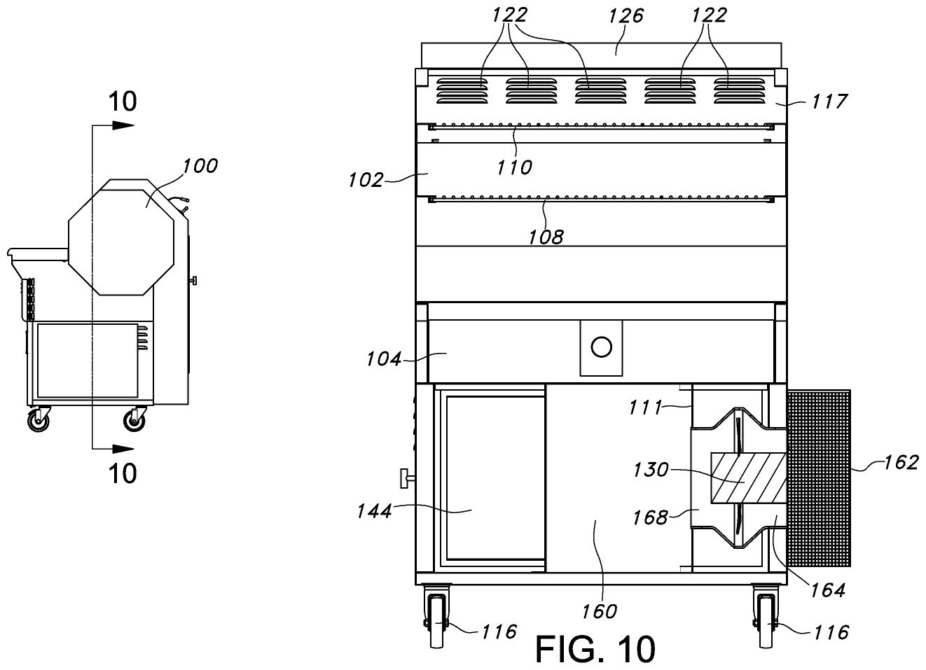

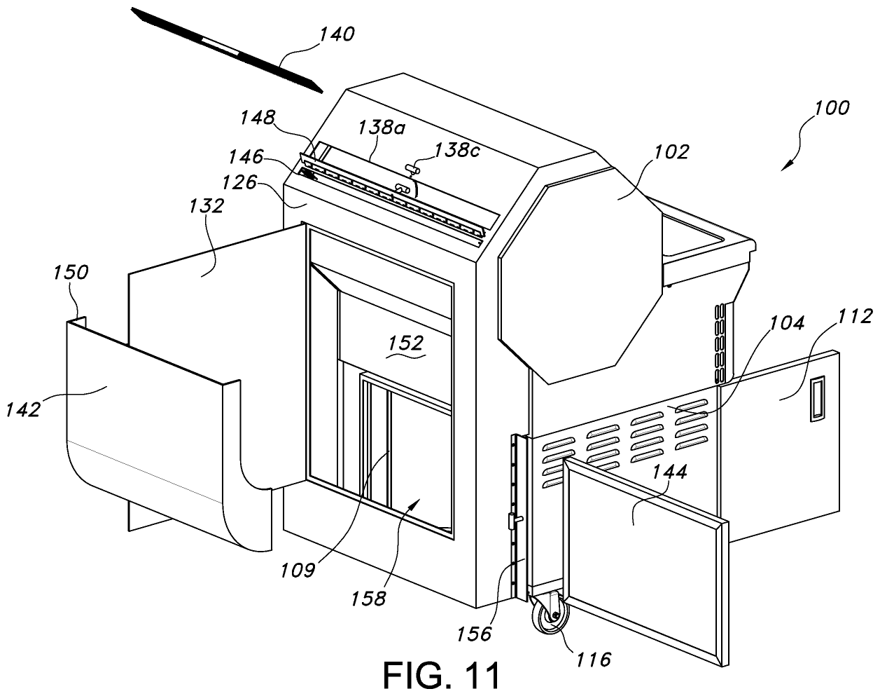

FIGS. 1-11 illustrate an example grill 100 with an integrated air filtration system 120 according to the principles of the present disclosure. The air filtration system 120 is configured to draw smoke from the cooking chamber 106 of the grill 100 and filter the smoke prior to expelling it from the grill 100.

As shown, the example grill 100 is a wood pellet type grill and comprises a grill body 102 and a cabinet assembly 104. The grill body 102 defines a cooking chamber 106. Although not shown, the cooking chamber 106 is normally enclosed by a lid that is hingedly attached to the grill body 102 in a common manner. The cooking chamber 106 includes two cooking grates 108, 110 supported by the grill body 102. The cabinet assembly 104 is configured to support the grill body 102 and includes a pair of doors 112, 114 that provide access to the interior of the cabinet assembly 104. The cabinet assembly 104 also includes four casters 116 to facilitate moving the grill 100 from one location to another. While the example grill 100 is a wood pellet type grill, the air filtration system 120 disclosed herein can be adapted for use with other grill types.

The air filtration system 120 comprises: a duct 126 that includes a series of filters; an air handling chamber 128 positioned within the cabinet assembly 104; and an exhaust blower 130 configured to draw smoke from the cooking chamber 106, through the air filtration system 120, before expelling the filtered smoke from the grill 100. The air filtration system 120 is in fluid communication with the cooking chamber 106 of the grill 100 via one or more vents 122 in a rear panel 117 of the grill body 102 and, in some implementations, an intake slot 124 positioned over the cooking chamber 106 of the grill 100.

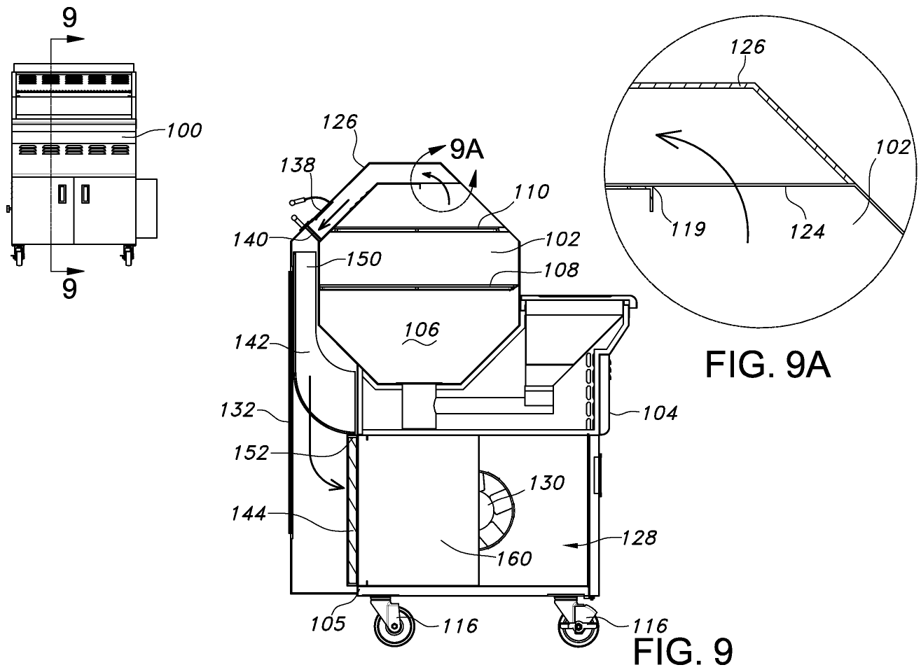

The intake slot 124 is an opening in the top panel 119 of the grill body 102 that places the cooking chamber 106 into fluid communication with the duct 126. The intake slot 124 is located adjacent the opening 107 into the cooking chamber 106 (see, e.g., FIG. 9A). In this way, smoke is drawn into the air filtration system 120 instead of exiting the cooking chamber 106 when the lid is opened.

The duct 126 of the air filtration system 120 is an enclosure configured to convey smoke from the cooking chamber 106 to the air handling chamber 128 in the cabinet assembly 104. Succinctly put, the duct 126 places the cooking chamber 106 into fluid communication with the air handling chamber 128. The duct 126 extends from the top panel 119 of the grill body 102 to the base 105 of the cabinet assembly 104, and includes a door 132 that provides access to the interior of the duct 126. The door 132 includes a T-shaped handle 134 and is attached to the duct 126 via hinges 136. The duct 126 and the door 132 may be constructed of stainless steel, or any other suitable material or combination of materials.

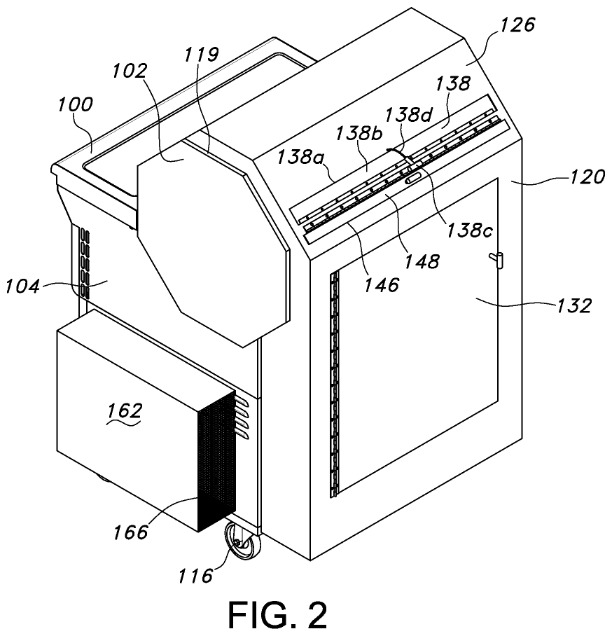

In some implementations, as shown, the duct 126 may include a bypass vent 138 configured to allow smoke from the cooking chamber 106 to pass through a portion of the duct 126 before exiting the air filtration system 120 into the ambient atmosphere. The bypass vent 138 comprises a slot 138a, a door 138b, a handle 138c, and a cable 138d. When the bypass vent 138 is closed, the door 138b is configured to seal the slot 138a (see e.g., FIGS. 2 and 9). When the bypass vent 138 is open, the door 138b is configured to seal the duct 126 and allow smoke to exit through the slot 138a without being filtered. The door 138b of the bypass vent 138 may be held closed by a magnetic strip, for example. The handle 138c of the bypass vent 138 is connected to the door 138b by the cable 138d. The cable 138d extends through an opening in the duct 126 adjacent the slot 138a. The handle 138c is used to close the door 138b and thereby the bypass vent 138.

The duct 126 includes three removable filters (140, 142, 144) positioned in series. The first and second filters 140, 142 are configured to entrap particulates, such as grease, and the third filter 144 is configured to entrap impurities associated with unpleasant odors.

The first filter 140 may include a filter material suitable for entrapping particulates and an internal wire frame that acts as a support structure for the filter material. The filter material may be wool, or wool in combination with another flame-retardant material suitable for entrapping particulates. The preferred implementation of the first filter 140 comprises a sock of wool material supported by a metal wire frame. Being the initial filter for smoke drawn from the cooking chamber 106 by the exhaust blower 130, it is anticipated that the first filter 140 will need to be replaced frequently. A slot 146 is defined within one side of the duct 106 to facilitate removal and replacement of the first filter 140. The slot 146 is covered by a door 148 hingedly attached to the duct 126.

The second filter 142, also referred to as a basket filter, may include a filter material suitable for entrapping particulates and an internal wire frame that acts as a support structure for the filter material. The filter material may be wool, or wool in combination with another flame-retardant material suitable for entrapping particulates. The second filter 142 is configured (e.g., shaped, and dimensioned) to prevent smoke, drawn from the cooking chamber 106 by the exhaust blower 130, from bypassing the second filter 142. The preferred implementation of the basket filter 142 is contoured to fill a portion of the duct 126 and comprises a sock of material supported by a metal wire frame. The basket filter 142 also defines a top opening 150 through which smoke enters the filter 142. The front end of the basket filter 142 is supported by a bracket 152 secured to an interior sidewall of the duct 126 (see, e.g., FIG. 9). The door 132 to the interior of the duct 126 facilitates removal and replacement of the basket filter 142.

The third filter 144 may include a filter material suitable for entrapping impurities within the smoke that cause unpleasant odor and an external frame that acts as a support structure for the filter material. The filter material includes activated carbon. In this way, the third filter 144 can reduce or eliminate odors. The third filter 144 is configured to cover the opening 158 connecting the duct 126 and the air handling chamber 128. In this way, all smoke drawn through the air filtration system 120 must pass through the third filter 144 before being drawn into the air handling chamber 128. A slot 154 is defined within one side of the duct 106 to facilitate removal and replacement of the third filter 144. The slot 154 is covered by a door 156 hingedly attached to the duct 126.

The air handling chamber 128 is located within the interior of the cabinet assembly 104 and includes at least one baffle 160. The opening 158 connecting the exit end of the duct 126 and the air handling chamber 128 extends through a back panel 109 of the cabinet assembly 104. This opening 158 places the duct 126 into fluid communication with the air handling chamber 128. The air handling chamber 128 is dimensioned to serve as an expansion chamber for filtered smoke exiting the duct 126 and at least one baffle 160 is positioned to affect (i.e., slow and direct) air flow through the air handling chamber 128. In this way, the filtered smoke is allowed to further cool before being expelled from the air filtration system 120 by the exhaust blower 130. The preferred implementation of the baffle 160 is a planar piece of sheet metal positioned to define a circuitous flow path through the air handling chamber 128. More specifically, the baffle 160 extends from a corner of the air handling chamber 128 that is adjacent the opening 158 connecting the duct 126 and the air handling chamber 128. The baffle 160 is preferably made of an aluminum alloy, but could be made of another heat-absorbing material (e.g., stainless steel).

The exhaust blower 130 is located within the interior of the cabinet assembly 104, adjacent to the air handling chamber 128. More specifically, the exhaust blower 130 is in fluid communication with the air handling chamber 128 via an inlet 168 in a side panel 111 that defines the air handling chamber 128. The exhaust blower 130 is a variable speed blower used to draw smoke from the cooking chamber 106, through the duct 126 and air handling chamber 128, and to expel the filtered smoke from the air filtration system 120. A deflector 162, positioned over the outlet 164 of the exhaust blower 130, is configured to direct filtered smoke expelled by the exhaust blower 130 into the ambient atmosphere behind the grill 100. The deflector 162 includes an exit opening covered by a mesh screen 166.

In some implementations, the exhaust blower 130 may be operated by a connected control dial. The control dial may be used to set the exhaust blower 130 to a first (low) speed while the cooking chamber 106 is closed and a second (high) speed while the cooking chamber 106 is open. In this way, when the cooking chamber 106 is open, excess smoke is drawn from the cooking chamber 106 and a person operating the grill 100 is prevented from coming into direct contact with smoke while cooking food on the grate(s) 108, 110.

Although not shown, an alternate embodiment of the air filtration system 120 could be adapted to work with a grill having an articulating hood. Such an embodiment may include a duct having a self-sealing joint.

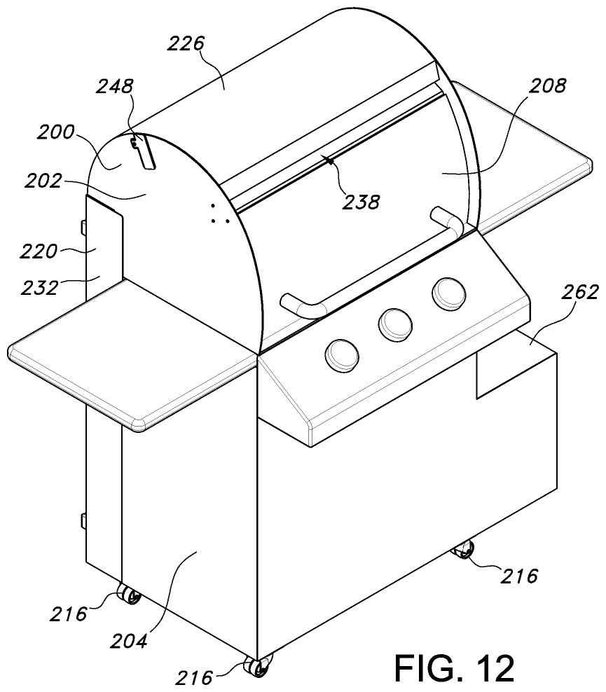

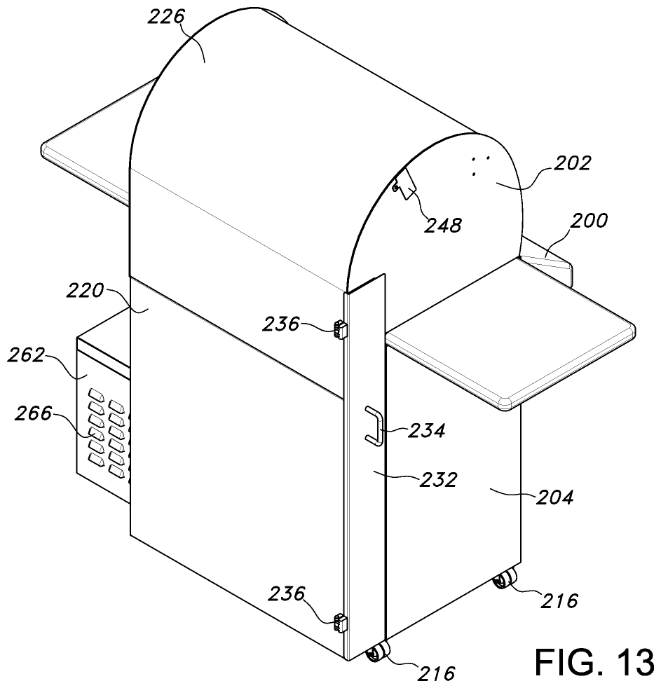

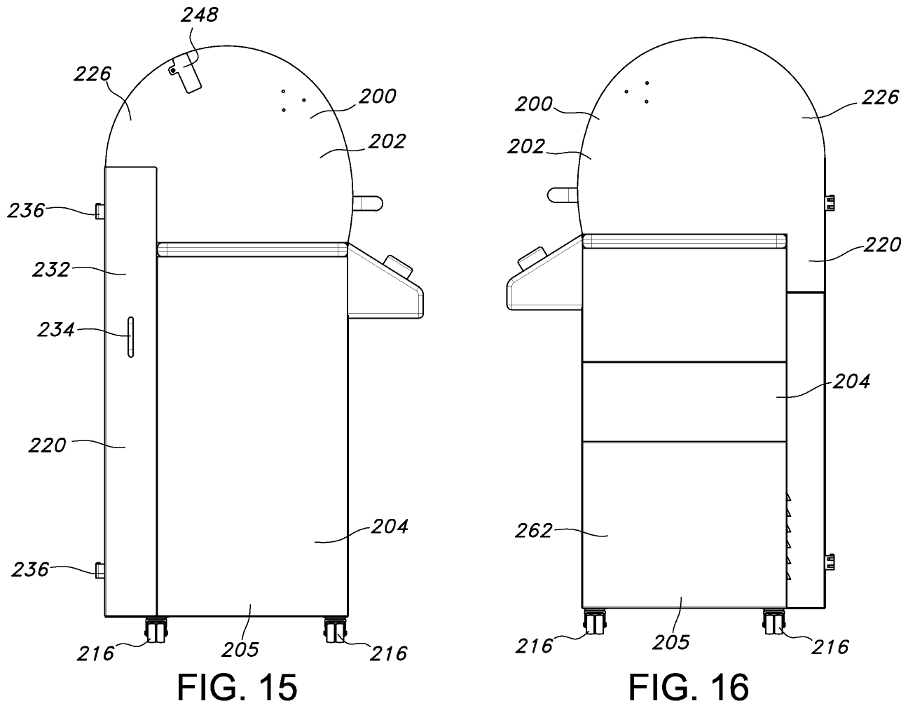

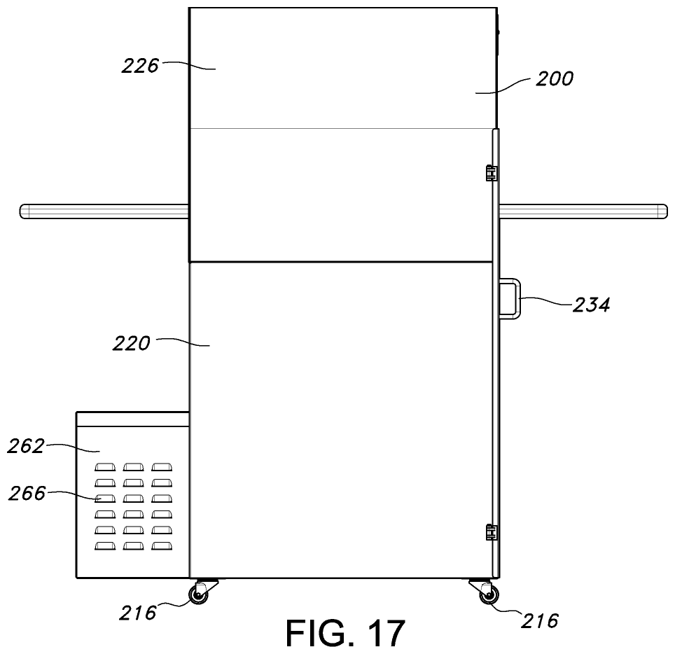

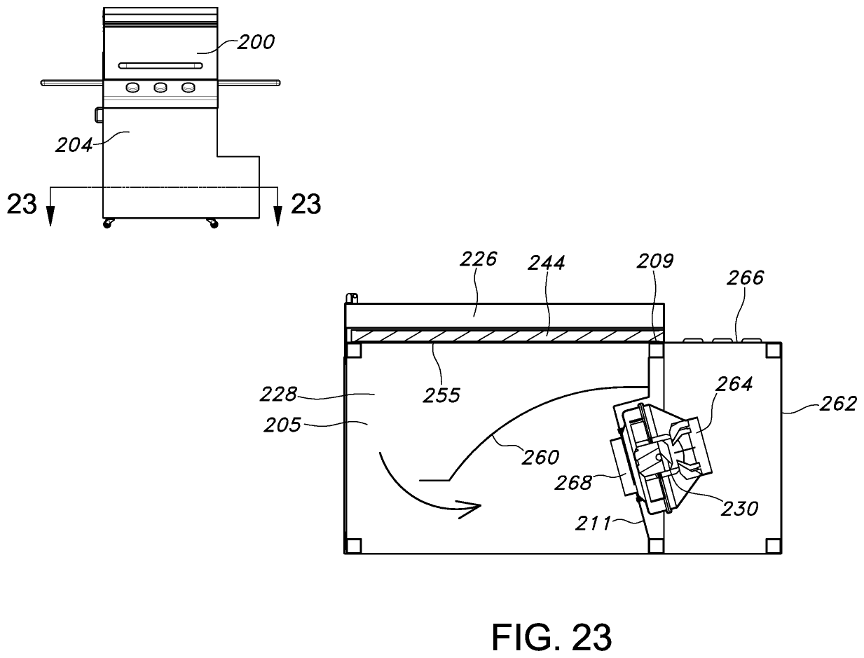

FIGS. 12-24 illustrate another example grill 200 with an integrated air filtration system 220 according to the principles of the present disclosure. The grill 200 and the integrated air filtration system 220 are similar to the grill 100 and air filtration system 120 shown in FIGS. 1-11, but the grill 200 is a propane-type grill and the air filtration system 220 incorporates a damper 270 used to regulate airflow between the cooking chamber 206 of the grill 200 and the air filtration system 220, and other changes.

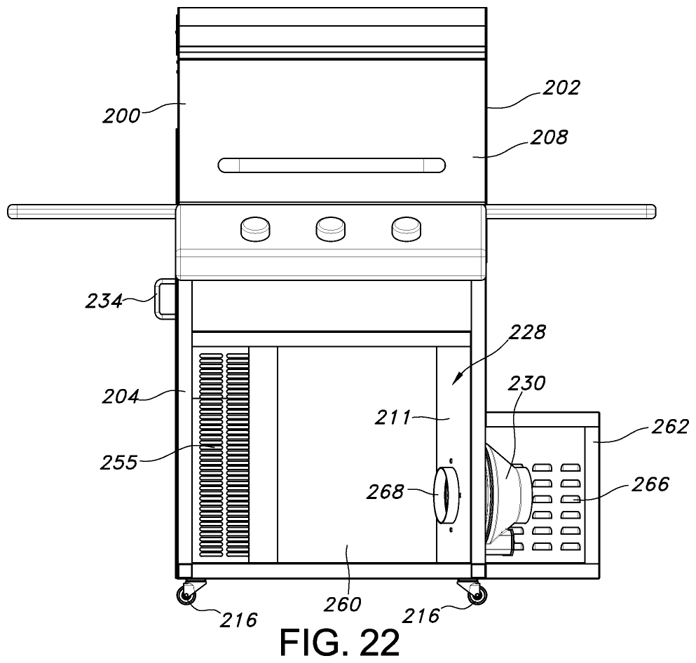

As shown, the example grill 200 is a propane-type grill and comprises a grill body 202 and a cabinet assembly 204. The grill body 202 defines a cooking chamber 206. The cooking chamber 206 is enclosed by a lid 208 that is hingedly attached to the grill body 202 in a common manner. Although not shown, one or more cooking grates can be placed in the cooking chamber 206 and supported by the grill body 202. The cabinet assembly 204 is configured to support the grill body 202 and includes a removable front panel that provide access to the interior of the cabinet assembly 204 (see, e.g., FIG. 22). The cabinet assembly 204 also includes four casters 216 to facilitate moving the grill 200 from one location to another. While the example grill 200 is a propane-type grill, the air filtration system 220 disclosed herein can be adapted for use with other grill types.

The air filtration system 220 comprises: a duct 226 that includes a series of filters; an air handling chamber 228 positioned within the cabinet assembly 204; and an exhaust blower 230 configured to draw smoke from the cooking chamber 206, through the air filtration system 220, before expelling the filtered smoke from the grill 200. The air filtration system 220 is in fluid communication with the cooking chamber 206 of the grill 200 via an intake slot 224 in the roof of the cooking chamber 206.

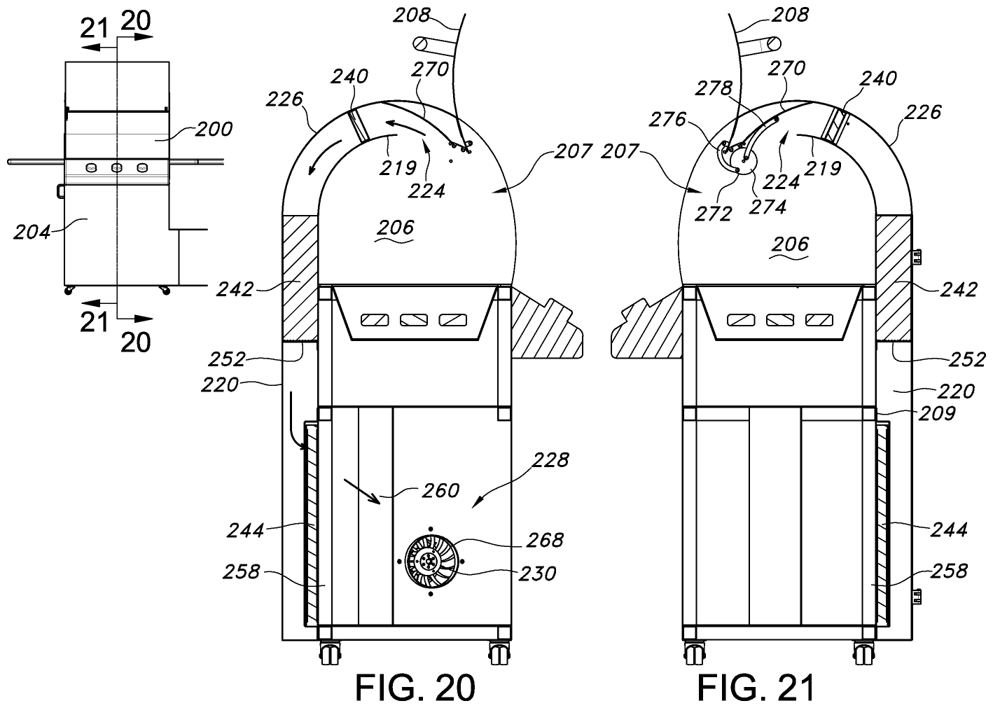

The intake slot 224 is an opening in the top panel 219 of the grill body 202 that places the cooking chamber 206 into fluid communication with the duct 226. The intake slot 224 is located adjacent the opening 207 into the cooking chamber 206 (see, e.g., FIG. 20). In this way, smoke is drawn into the air filtration system 220 instead of exiting the cooking chamber 206 when the lid 208 is opened.

The air filtration system 220 also includes a damper 270. The damper 270 is operably connected to the lid 208 and configured to selectively occlude the intake slot 224. This connection between the damper 270 and lid 208 is such that opening the lid 208 causes the damper 270 to lift, thereby uncovering the intake slot 224 and allowing smoke to be drawn into the air filtration system 220. Conversely, when the lid 208 is closed, the damper 270 moves to overlay the intake slot 224. In this way, the damper 270 blocks the intake slot 224, thereby preventing smoke from being drawn through it and into the air filtration system 220. In the preferred implementation, the damper 270 is mechanically connected to the lid 208 by a cam-driven mechanism 272 The cam-driven mechanism 272 includes a circular cam 274 and two curved linkage arms 276, 278. The cam 274 is secured to a sidewall of the grill body 202 using a fastener (e.g., a Chicago screw). One linkage arm 276 connects the cam 274 to the lid 208 and the other linkage arm 278 connects the cam 274 to the damper 270. The ends of both linkage arms 276, 278 are connected using fasteners, such as Chicago screws, that allow the linkage arms 276, 278 to rotate. The cam-driven mechanism 272 allows for precise and controlled movement of the damper 270 in response to the opening and closing of the lid 208.

The duct 226 of the air filtration system 220 is an enclosure configured to convey smoke from the cooking chamber 206 to the air handling chamber 228 in the cabinet assembly 204. Succinctly put, the duct 226 places the cooking chamber 206 into fluid communication with the air handling chamber 228. The duct 226 extends from the top panel 219 of the grill body 202 to the base 205 of the cabinet assembly 204, and includes a door 232 that provides access to the interior of the duct 226. The door 232 includes a U-shaped handle 234 and is attached to the duct 226 via hinges 236. The duct 226 and the door 232 may be constructed of stainless steel, or any other suitable material or combination of materials.

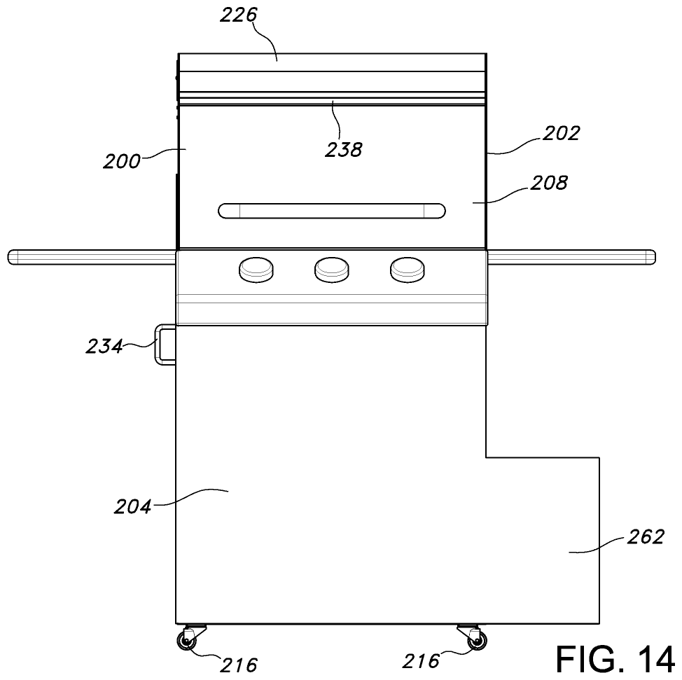

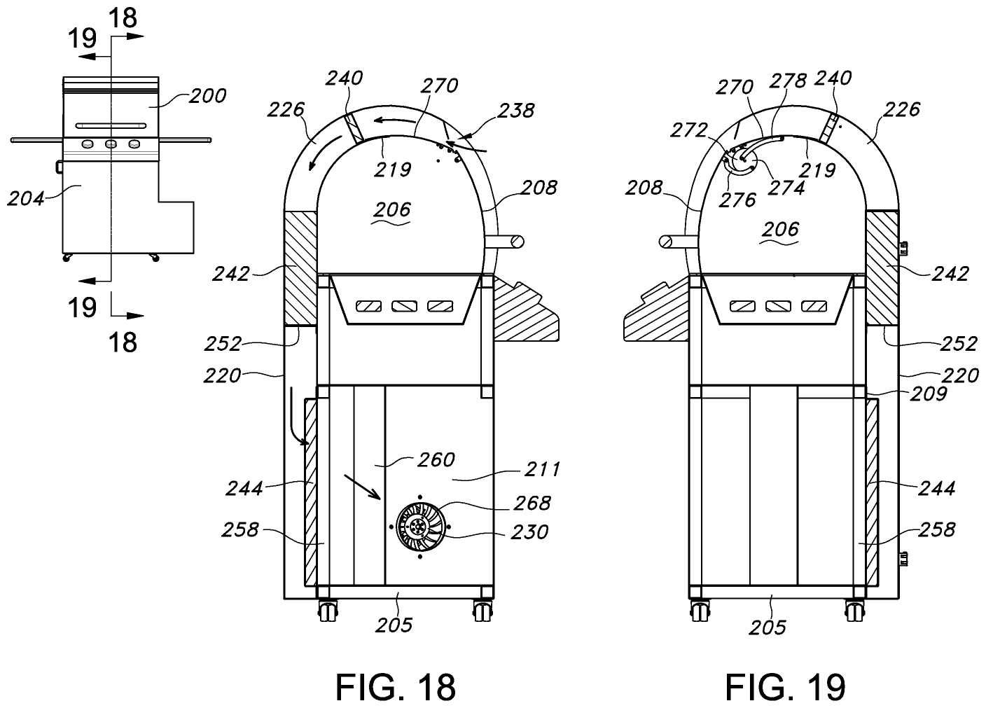

As shown, in some implementations, the duct 226 may include an intake vent 238 disposed in one end. The intake vent 238 is an elongate slot positioned above the lid 208 through which smoke leaking from the closed lid 208 of the grill 200 and air from the surrounding environment are drawn into the air filtration system 200 (see, e.g., FIGS. 14 and 18). This serves to both minimize the amount of unfiltered smoke escaping into the environment and to cool the air filtration system 220. The intake vent 238 is blocked by the damper 270 when the lid 208 is opened (see, e.g., FIGS. 20 and 21).

The duct 126 includes three removable filters (240, 242, 244) positioned in series. The first and second filters 240, 242 are configured to entrap particulates, such as grease, and the third filter 244 is configured to entrap impurities associated with unpleasant odors.

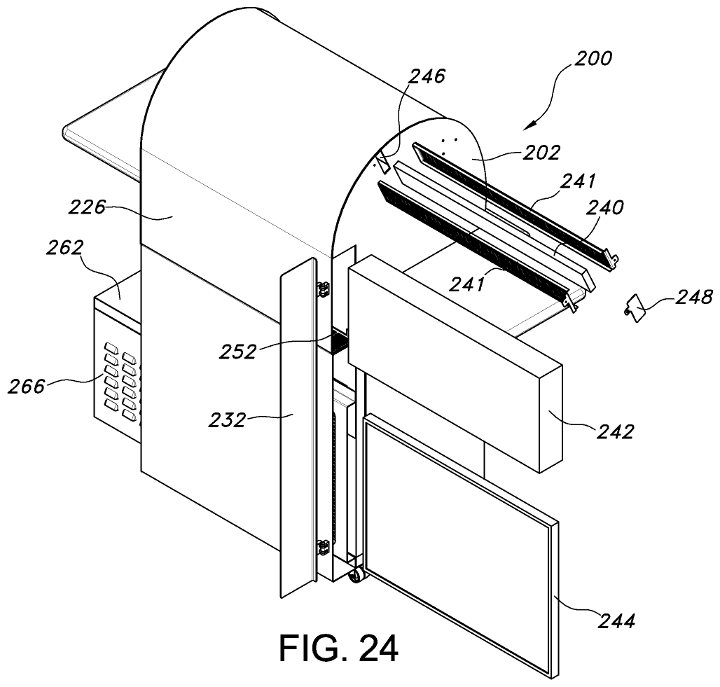

The first filter 240 may include a filter material suitable for entrapping particulates and an external frame that acts as a support structure for the filter material. The filter material may be wool, or wool in combination with another flame-retardant material suitable for entrapping particulates. The preferred implementation of the first filter 240 comprises one or more layers of material supported by a rectangular shaped metal frame. The first filter 240 may be positioned between two heat shields 241. Each heat shield 241 is a perforated sheet of metal configured to allow smoke to be drawn through the first filter 240. Each heat shield 241 may be made of copper, a copper alloy, or another suitable heat-absorbing material. Being the initial filter for smoke drawn from the cooking chamber 206 by the exhaust blower 230, it is anticipated that the first filter 240 will need to be replaced frequently. A slot 246 is defined in a lateral side of the duct 206 to facilitate removal and replacement of the first filter 240 (see, e.g., FIG. 24). The slot 246 is enclosed by a cover 248 secured to the duct 226 by a threaded fastener (e.g., a screw).

The second filter 242 may include a filter material suitable for entrapping particulates and an internal wire frame that acts as a support structure for the filter material. The filter material may be wool, or wool in combination with another flame-retardant material suitable for entrapping particulates. The second filter 242 is configured (e.g., shaped, and dimensioned) to prevent smoke, drawn from the cooking chamber 206 by the exhaust blower 230, from bypassing the second filter 242. The preferred implementation of the second filter 242 is configured to fill a portion of the duct 226 and comprises a sock of material, or a bag, supported by a metal wire frame. The second filter 242 is supported by a grate 252 positioned in the duct 226. The grate 252 acts as a heat shield, reducing the overall temperature of the filtered smoke before it reaches the exhaust blower 230, and may be made of copper, a copper alloy, or another suitable heat-absorbing material. The door 232 to the interior of the duct 226 facilitates removal and replacement of the second filter 242.

The third filter 244 may include a filter material suitable for entrapping impurities within the smoke that cause unpleasant odor and an external frame that acts as a support structure for the filter material. The filter material includes activated carbon. In this way, the third filter 244 can reduce or eliminate odors. The third filter 244 is configured to cover the opening 258 connecting the duct 226 and the air handling chamber 228. In this way, all smoke drawn through the air filtration system 220 must pass through the third filter 244 before being drawn into the air handling chamber 228. The door 232 to the interior of the duct 226 also facilitates removal and replacement of the third filter 244.

In some implementations, a heat shield 255 configured to reduce the overall temperature of the filtered smoke before it reaches the exhaust blower 230 may be positioned between the third filter 244 and the air handling chamber 228 (see, e.g., FIG. 22). The heat shield 255 extends to cover the opening 258 and is a perforated sheet of metal configured to allow filtered smoke to be drawn through the third filter 244. The heat shield 255 may be made of copper, a copper alloy, or another suitable heat-absorbing material.

The air handling chamber 228 is located within the interior of the cabinet assembly 204 and includes at least one baffle 260. The opening 258 connecting the exit end of the duct 226 and the air handling chamber 228 extends through a back panel 209 of the cabinet assembly 204. This opening 258 places the duct 226 into fluid communication with the air handling chamber 228. The air handling chamber 228 is dimensioned to serve as an expansion chamber for filtered smoke exiting the duct 226 and at least one baffle 260 is positioned to affect (i.e., slow and direct) air flow through the air handling chamber 228. In this way, the filtered smoke is allowed to further cool before being expelled from the air filtration system 220 by the exhaust blower 230. The preferred implementation of the baffle 260 is a curved piece of sheet metal positioned to define a circuitous flow path through the air handling chamber 228. More specifically, the baffle 260 extends from a side panel 211 of the air handling chamber 228, and is positioned between the opening 258 into the air handling chamber 228 and an inlet 268 of the exhaust blower 230. The baffle 260 is preferably made of a heat-absorbing material, such as, but not limited to, copper or a copper alloy.

The exhaust blower 230 is located within the interior of the cabinet assembly 204, adjacent to the air handling chamber 228. More specifically, the exhaust blower 230 is in fluid communication with the air handling chamber 228 via the inlet 268 in a side panel 211 that defines the air handling chamber 228. The exhaust blower 230 is a variable speed blower used to draw smoke from the cooking chamber 206, through the duct 226 and air handling chamber 228, and to expel the filtered smoke from the air filtration system 220. A deflector 262, positioned over the outlet 264 of the exhaust blower 230, is configured to direct filtered smoke expelled by the exhaust blower 230 into the ambient atmosphere behind the grill 200. The deflector 262 includes an exit opening with a vented covering 266.

In some implementations, the exhaust blower 230 may be operated by a connected control dial. The control dial may be used to set the exhaust blower 230 to a first (low) speed while the cooking chamber 206 is closed and a second (high) speed while the cooking chamber 206 is open. In this way, when the cooking chamber 206 is open, excess smoke is drawn from the cooking chamber 206 and a person operating the grill 200 is prevented from inhaling smoke while placing food into and/or removing food from the cooking chamber 206.

The foregoing description of the invention is intended to be illustrative; it is not intended to be exhaustive or to limit the claims to the precise forms disclosed. Those skilled in the relevant art can appreciate that many modifications and variations are possible in light of the foregoing description and associated drawings.

Reference throughout this specification to an “embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. An air filtration system for a grill with a cabinet assembly and a grill body that defines a cooking chamber, the air filtration system comprising:
a duct that includes a series of filters;
an air handling chamber positioned within the cabinet assembly; and
an exhaust blower;
wherein:
the air filtration system is in fluid communication with the cooking chamber of the grill via at least one vent in a portion of the grill body that separates the cooking chamber and the duct; and
the exhaust blower is configured to draw smoke from the cooking chamber, through the duct and the series of filters, and then through the air handling chamber, before expelling filtered smoke from the grill.

2. The air filtration system of claim 1, wherein the air handling chamber is dimensioned to serve as an expansion chamber for filtered smoke exiting the duct, and includes at least one baffle positioned to affect air flow through the air handling chamber.

3. The air filtration system of claim 2, wherein the duct of the air filtration system is an enclosure configured to convey smoke from the cooking chamber to the air handling chamber in the cabinet assembly.

4. The air filtration system of claim 3, wherein the exhaust blower is positioned adjacent to and is in fluid communication with the air handling chamber.

5. The air filtration system of claim 1, wherein the series of filters is three removable filters positioned in series within the duct, the first and second filters are configured to entrap vaporized particles of oil and fat, and the third filter is configured to entrap impurities associated with unpleasant odors.

6. The air filtration system of claim 5, wherein the first filter includes a wool material, the second filter includes a wool material, and the third filter includes activated carbon.

7. An air filtration system for a grill that includes a cabinet assembly, a grill body that defines a cooking chamber, and a lid, the air filtration system comprising:
a duct that includes a series of filters;
a damper;
an air handling chamber positioned within the cabinet assembly; and
an exhaust blower;
wherein:
the air filtration system is in fluid communication with the cooking chamber of the grill via an intake slot in a portion of the grill body that separates the cooking chamber and the duct;
the damper is operably connected to the lid and configured to selectively occlude the intake slot; and
the exhaust blower is configured to draw smoke from the cooking chamber, through the duct and the series of filters, and then through the air handling chamber, before expelling filtered smoke from the grill.

8. The air filtration system of claim 7, wherein the air handling chamber is dimensioned to serve as an expansion chamber for filtered smoke exiting the duct, and includes at least one baffle positioned to affect air flow through the air handling chamber.

9. The air filtration system of claim 8, wherein the duct of the air filtration system is an enclosure configured to convey smoke from the cooking chamber to the air handling chamber in the cabinet assembly.

10. The air filtration system of claim 9, wherein the exhaust blower is positioned adjacent to and is in fluid communication with the air handling chamber.

11. The air filtration system of claim 7, wherein the series of filters is three removable filters positioned in series within the duct, the first and second filters are configured to entrap vaporized particles of oil and fat, and the third filter is configured to entrap impurities associated with unpleasant odors.

12. The air filtration system of claim 11, wherein the first filter includes a wool material, the second filter includes a wool material, and the third filter includes activated carbon.

13. The air filtration system of claim 7, wherein opening the lid causes the damper to uncover the intake slot and closing the lid causes the damper to cover the intake slot.

14. The air filtration system of claim 13, wherein the damper is operably connected to the lid by a cam-driven mechanism, which includes a circular cam and two curved linkage arms used to operably connect the circular cam to both the damper and the lid.
